(19) United States
(12) Patent Application Publication
(10) Pub. No.: US 2002/0088676 A1
(43) Pub. Date: Jul. 11, 2002

(54) Shock absorber containing biodegradable fluid

(76) Inventor: Eugene R. Zehler, West Chester, OH (US)

Correspondence Address: COGNIS CORPORATION, 2500 RENAISSANCE BLVD., SUITE 200, GULPH MILLS, PA, 19406

(21) Appl. No.: 10/051,938

(22) Filed: Jan. 17, 2002

Related U.S. Application Data
(63) Continuation of application No. 08/760,055, filed on Dec. 4, 1996.

(51) Int. Cl. F16D 57/00

(52) U.S. Cl. 188/266

(57) ABSTRACT

A shock absorber is comprised of a cylinder defining a chamber therein, the cylinder containing a fluid; a piston rod sealingly projecting into the cylinder and being axially displaceable with respect to the cylinder; a piston being attached to the piston rod, the piston being slidably disposed within the cylinder to sealingly divide the cylinder into first and second chambers; means for permitting fluid communication between the first and second chambers; the means for permitting fluid communication being disposed in at least a portion of the piston. The fluid is comprised of a polyol ester the polyol component of which is a hindered polyol and the carboxylic acid component is a mono-carboxylic acid having from about 5 to about 18 carbon atoms.

### BACKGROUND OF THE INVENTION

1. Field of the Invention

The present invention relates to a shock absorber containing one or more biodegradable esters as the dampening fluid.

2. Description of the Related Art

Vehicles, machinery and other types of equipment are normally equipped with hydraulic systems which convert vibrational energy into heat and thus have a dampening effect. Such dampeners are most frequently used in vehicles (wheel and steering dampeners) and are usually known as shock absorbers. The function of the hydraulic fluid, also known as a dampening fluid, is the same in all design variants (single or twin-tube absorbers); the requirements differ mostly with respect to wear protection and viscosity or viscosity-temperature characteristics. In operation, the forced flow of the oil through narrow channels from the loaded chamber to the compensating chamber raises the oil temperature to 60-100° C., depending on the load (in special cases up to 150° C.); this heat is removed by the air stream of the moving vehicle. On the other hand, the dampeners must remain operational also at low ambient temperatures; this requires low-viscosity oils with good cold properties.

Historically, dampening fluids have been based on mineral oil or low molecular weight poly-α-olefins (PAO). Both types of fluids contain high levels of polymer to boost Viscosity Index (VI) to about 250 because high VI fluids offer more consistent dampening characteristics over their typical operating temperature range of −40 to +80° C. Because the typical mineral oil- and PAO-based fluids contain polymeric VI improvers which degrade as a result of exposure to the mechanical shearing stresses inside the shock absorber, the viscosity of these fluids decreases over time.

Even though shock absorber manufacturers recommend that the fluids be drained and recycled, such guidelines are not always strictly followed. Consequently, shock absorber fluids leak out and get into the environment and present health and safety hazards. Thus, there is a need for shock absorbers that contain biodegradable fluids that, if introduced into the environment, would have little or no deleterious effects because they are biodegradable.

### SUMMARY OF THE INVENTION

Shock absorbers according to the invention are comprised of: a cylinder defining a chamber therein, the cylinder containing a fluid; a piston rod sealingly projecting into the cylinder and being axially displaceable with respect to the cylinder; a piston being attached to the piston rod, the piston being slidably disposed within the cylinder to sealingly divide the cylinder into first and second chambers; means for permitting fluid communication between the first and second chambers; the means for permitting fluid communication being disposed in at least a portion of the piston. The fluid is comprised of one or more polyol esters the polyol component of which is a hindered polyol and the carboxylic acid component is a mono-carboxylic acid having from about 5 to about 18 carbon atoms. Since the shock absorber fluid according to the invention does not contain any polymeric viscosity index improver, the viscosity of the fluid does not degrade as a result of exposure to the mechanical shearing stresses inside the shock absorber.

### BRIEF DESCRIPTION OF THE DRAWINGS

FIG. 1 is a longitudinal view of a shock absorber.

### DESCRIPTION OF THE PREFERRED EMBODIMENTS

The dampening fluids according to the invention are comprised of one or more polyol esters, the polyol component of which is a hindered polyol and the carboxylic acid component is a mono-carboxylic acid having from about 5 to about 18 carbon atoms. A hindered polyol is a molecule having no beta hydrogen atoms and 2 or more alcohol functionalities. A beta hydrogen atom is a hydrogen atom bonded to a carbon atom which is adjacent to a carbon atom bonded to a functional group such as an OH group. In the case of a polyol, a beta hydrogen is a hydrogen atom bonded to a carbon atom which is adjacent to a carbon atom bonded to an alcohol functionality. An example of a polyol having two beta hydrogen atoms is 1,3-propanediol. Trimethylolpropane, on the other hand, is an example of a hindered polyol having no beta hydrogen atoms and 3 alcohol functionalities. Examples of hindered polyols include, but are not limited to, trimethylolpropane, pentaerythritol, dipentaerythritol, neo-pentyl glycol and the like.

The carboxylic acid components of the polyol esters according to the invention are aliphatic carboxylic acids having from 5 to 18 carbon atoms. Thus, the polyol esters suitable for use in the shock absorbers according to the invention are hindered polyol esters of C₅₋₁₈ carboxylic acids. The C₅₋₁₈ carboxylic acids can be linear or branched and are preferably linear. The esters according to the invention can be made by the method described in U.S. Pat. No. 5,021,179, the entire contents of which are incorporated herein by reference. The final formulated shock absorber fluid will contain individual hindered polyol esters of C₅₋₁₈ carboxylic acids or combinations of 2 or more of such esters and will also typically contain antioxidants, corrosion inhibitors, antiwear additives and seal conditioners.

The biodegradability of the shock absorber fluids according to the invention is determined by the Co-ordinating European Counsel standard test method L-33-A-94 (Primary biodegradation Test, abbreviated C.E.C L-33-A-94), the entire contents of which are incorporated herein by reference. In order to be considered biodegradable, a fluid must be at least 80% biodegradable. An acceptable biodegradable shock absorber fluid should exhibit at least the following properties:

| Viscosity at −40° C. | 250-5,000 | cs |
|---|---|---|
| Viscosity at 40° C. | 10-15 | cs |
| Viscosity at 100° C. | 2.5-4.0 | cs |
| Viscosity index | 90-300 | |
| Pour Point | −50° C. | |
| Flash Point | 100° C. | (min) |
| Rust Test (ASTM D-665A) | Pass | |
| Four Ball Wear¹ | 0.30-0.35 | mm |
| Foam Test (ASTM D-892) | <50 | ml |
| Biodegradability (C.E.C L-33-A-94) | ≧80% | |
| 1-20 kg, 1800 RPM, 54° C., 1 hr. | | |

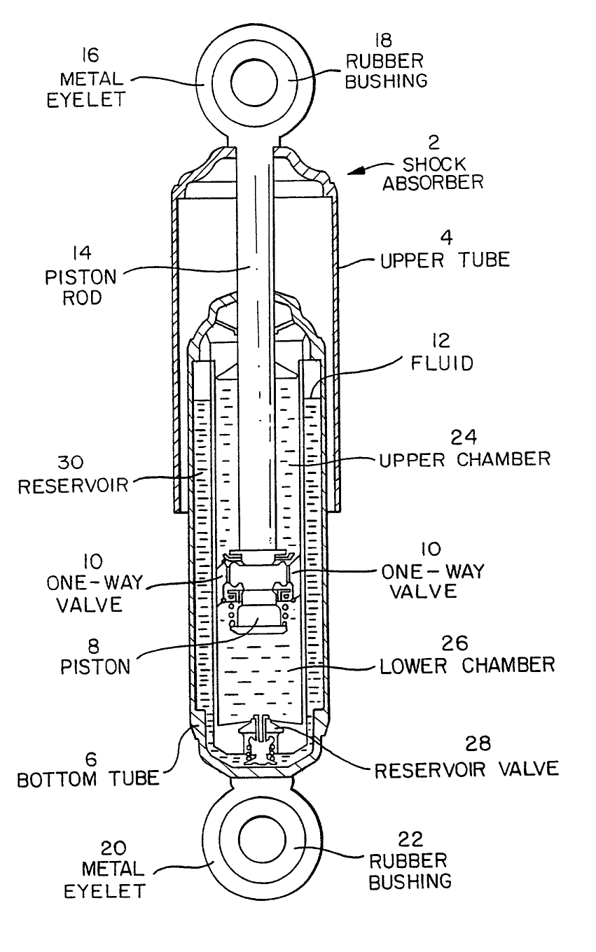

A typical shock absorber is depicted in FIG. 1. The shock absorber 2 includes an upper tube 4 partially surrounding and concentric with a bottom tube 6, a piston 8 centrally located along the longitudinal axis of the bottom tube 6, whereby the bottom tube 8 is free to move partially further into and out of the upper tube 4 in a telescoping manner slidably past the piston 8, one-way valves 10 are located between the piston 8 and the inside wall of bottom tube 6 while assisting in maintaining a fluid seal therebetween, and hydraulic fluid 12 substantially fills bottom tube 6. The piston 8 includes calibrated orifices, and is rigidly connected to one end of a piston rod 14. The other end of piston rod 14 is rigidly connected to, or formed into, a metal eyelet 16 retaining a rubber bushing 18 for bolting the upper tube 4 to an associated automobile frame, the piston rod 14 and upper tube 4 being rigidly connected together near the metal eyelet 16. The bottom tube 6 is rigidly connected at its lower end to a metal eyelet 20 containing a bushing 22 of elastomeric material, for bolting the bottom tube 6 to a suspension component. A tight fit is maintained between the piston 8 and the inside walls of bottom tube 6, dividing the latter into an upper chamber 24 and a lower chamber 26. A two-way reservoir valve 28 provides for a reservoir chamber 30 containing extra hydraulic fluid 12 to deliver fluid 12 to or receive fluid 12 from the lower chamber 26 for movement of the bottom tube 6 away from or into the upper tube 4, respectively.

The operation of the shock absorber 2 is well known. When an associated tire hits a bump, the lower or bottom tube 6 telescopes into the upper tube 4, causing the piston 8 to penetrate further into the bottom tube 6. On rebound of an associated tire or wheel, the opposite movement occurs, with the bottom tube 6 moving downward and telescoping partially out of the upper tube 4. During such movement between the upper tube 4 and bottom tube 6, the valves 10 and 28 permit hydraulic fluid 12 to move in an appropriate direction between upper chamber 24, lower chamber 26, and reservoir 30, for in combination with piston 8 dampening the telescopic movement therebetween.

The following examples are meant to illustrate but not to limit the invention.

### EXAMPLE 1

A shock absorber fluid, which contained the following ingredients in parts by weight, was found to possess properties listed in Table 1 comparable to a commercially available mineral oil based product.

| | |
|---|---|
| EMERY ® 2930¹ | 98.83 |
| VANLUBE ® 81² | 0.50 |
| PANA | 0.50 |
| QUINIZARIN | 0.02 |
| IRGALUBE ® 349³ | 0.15 |

¹an ester of trimethylolpropane and EMERY ® 1210 acids which is a mixture of monocarboxylic acids composed of 4% valeric acid, 27% caproic acid, 30% enanthic acid, 12% caprylic acid, 27% pelargonic acid.
²trademark product of R. T. Vanderbilt
³trademark product of Ciba-Geigy

TABLE 1

| | Commercial Product¹ | Example 1 |
|---|---|---|
| Viscosity, 100° C., cs | 4.72 | 3.70 |
| Viscosity, 40° C., cs | 15.48 | 15.69 |
| Viscosity, −40° C., cs | no flow | 2984 |
| Viscosity, BF^{a}, −25° C., cp | 646 | 679 |
| Viscosity, BF^{a}, −40° C., cp | 3161 | 3229 |
| Viscosity, BF^{b}, −40° C., cycled, cp | 7392 | 3235 |
| Viscosity Index | 259 | 124 |
| Acid Value, mg KOH/g | 1.00 | 0.26 |
| Flash Point, ° C. | 146 | 238 |
| Fire Point, ° C. | 149 | 271 |
| Pour Point, ° C. | −59 | −73 |
| Foam Test, D-892, Seq I, ml | 35 | nil |
| Rust Test, D-665A | Pass | Pass |
| Four Ball Wear Test^{c} mm | 0.31 | 0.32 |
| Biodegradability, %^{d} | <50 | >90 |
| Pin & Vee Block Wear Test^{e} | | |
| Wear, teeth | 12 | 14 |
| Wear, mg | 6.2 | 5.9 |
| Oxidation and Corrosion Test^{f} | | |
| ΔAcid Value, mg KOH/g | 19.9 | 0.15 |
| % Δ Viscosity, 40° C. | 34.6 | 4.1 |
| % Δ Viscosity, 100° C. | 7.4 | 3.0 |
| Sludge, mg | Unfilterable | 1.8 |
| Copper, Δmq/cm2 | −1.384 | −0.615 |
| Steel 1, Δmq/cm2 | 0.015 | 0 |
| Steel 2, Δmq/cm2 | 0.031 | 0 |
| Steel 3, Δmq/cm2 | 0.023 | 0 |
| Seal Compatibility^{g} | | |
| Hardness | similar | similar |
| Spew | similar | similar |
| Thermoqravimetric Analysis^{h} | | |
| ° C. @ 5% Loss | 124 | 214 |
| ° C. @ 10% Loss | 138 | 230 |
| ° C. @ 50% Loss | 182 | 275 |
| ° C. @ 90% Loss | 208 | 298 |

^{a}BF = Brookfield Viscosity; 16 hr soak
^{b}16 hr soak @ −40° C., 3 days @ 25° C., 16 hr soak @ −40° C.
^{c}20 kg, 1800 RPM, 54° C., 1 hr
^{d}CEC L-33-A-94 Primary Biodegradation Test
^{e}200 lbs, 4 hrs
^{f}149° C., 5 liters air/hr, 7 days
^{g}100° C., 7 days,
^{h}10° C./min, Nitrogen sweep, 14 mg sample
¹-SUNFIL ® DM 4463; a trademark product of Sun Chemical

What is claimed is:

1. A shock absorber comprising a cylinder defining a chamber therein, the cylinder containing a fluid; a piston rod sealingly projecting into the cylinder and being axially displaceable with respect to the cylinder; a piston being attached to the piston rod, the piston being slidably disposed within the cylinder to sealingly divide the cylinder into first and second chambers; means for permitting fluid communication between the first and second chambers; the means for permitting fluid communication being disposed in at least a portion of the piston; wherein said fluid is comprised of a polyol ester the polyol component of which is a hindered polyol and the carboxylic acid component is a mono-carboxylic acid having from about 5 to about 18 carbon atoms.

2. The shock absorber of claim 1 wherein said polyol is trimethylolpropane.

3. The shock absorber of claim 1 wherein said monocarboxylic acid has from about 5 to about 10 carbon atoms.

4. The shock absorber of claim 3 wherein said monocarboxylic acid is branched acid.

5. The shock absorber of claim 4 wherein said branched acid has from about 5 to about 10 carbon atoms.

6. The shock absorber of claim 1 wherein said ester is an ester of trimethylolpropane and a mixture of carboxylic acids having from 5 to 9 carbon atoms.

7. The shock absorber of claim 1 further comprising an antioxidant, a corrosion inhibitor, an antiwear additive, a seal conditioner, and combinations thereof.

8. A shock absorber comprising a cylinder defining a chamber therein, the cylinder containing a fluid; a piston rod sealingly projecting into the cylinder and being axially displaceable with respect to the cylinder; a piston being attached to the piston rod, the piston being slidably disposed within the cylinder to sealingly divide the cylinder into first and second chambers; means for permitting fluid communication between the first and second chambers; the means for permitting fluid communication being disposed in at least a portion of the piston; wherein said fluid is comprised of an ester of trimethylolpropane and a mixture of carboxylic acids having from 5 to 9 carbon atoms.

9. The shock absorber of claim 8 further comprising an antioxidant, a corrosion inhibitor, an antiwear additive, a seal conditioner, and combinations thereof.

10. In a shock absorber including hydraulic fluid substantially filling a bottom tube that moves slidably past a piston for telescoping into and out of an outer concentric upper tube, with valve means being located about said piston, for controlling the movement of said hydraulic fluid between upper and lower chambers formed on either side of said piston within said bottom tube, for dampening the movement of said bottom tube into and out of said upper tube, wherein the improvement comprises hydraulic fluid selected from the group consisting of a polyol ester, the polyol component of which is a hindered polyol and the carboxylic acid component is a mono-carboxylic acid having from about 5 to 18 carbon atoms, and an ester of trimethylolpropane and a mixture of carboxylic acids having from 5 to 9 carbon atoms.

11. The shock absorber of claim 10 wherein said polyol is trimethylolpropane.

12. The shock absorber of claim 10 wherein said monocarboxylic acid has from about 5 to about 10 carbon atoms.

13. The shock absorber of claim 12 wherein said monocarboxylic acid is branched acid.

14. The shock absorber of claim 13 wherein said branched acid has from about 5 to about 10 carbon atoms.

15. The shock absorber of claim 10 wherein said ester is an ester of trimethylolpropane and a mixture of carboxylic acids having from 5 to 9 carbon atoms.

16. The shock absorber of claim 10 further comprising an antioxidant, a corrosion inhibitor, an antiwear additive, a seal conditioner, and combinations thereof.

17. In a shock absorber including hydraulic fluid substantially filling a bottom tube that moves slidably past a piston for telescoping into and out of an outer concentric upper tube, with valve means being located about said piston, for controlling the movement of said hydraulic fluid between upper and lower chambers formed on either side of said piston within said bottom tube, for dampening the movement of said bottom tube into and out of said upper tube, wherein the improvement comprises hydraulic fluid comprised of an ester of trimethylolpropane and a mixture of carboxylic acids having from 5 to 9 carbon atoms.

18. The shock absorber of claim 17 further comprising an antioxidant, a corrosion inhibitor, an antiwear additive, a seal conditioner, and combinations thereof.

19. An automotive shock absorber including hydraulic fluid for dampening the movement of associated mechanical members wherein the improvement comprises hydraulic fluid including a polyol ester the polyol component of which is a hindered polyol and the carboxylic acid component is a mono-carboxylic acid having from about 5 to 18 carbon atoms.

20. The shock absorber of claim 20 wherein said polyol is trimethylolpropane.

21. The shock absorber of claim 20 wherein said monocarboxylic acid has from about 5 to about 10 carbon atoms.

22. The shock absorber of claim 21 wherein said monocarboxylic acid is branched acid.

23. The shock absorber of claim 22 wherein said branched acid has from about 5 to about 10 carbon atoms.

24. The shock absorber of claim 20 wherein said ester is an ester of trimethylolpropane and a mixture of carboxylic acids having from 5 to 9 carbon atoms.

25. The shock absorber of claim 20 further comprising an antioxidant, a corrosion inhibitor, an antiwear additive, a seal conditioner, and combinations thereof.

26. An automotive shock absorber including hydraulic fluid for dampening the movement of associated mechanical members wherein the improvement comprises hydraulic fluid comprised of an ester of trimethylolpropane and a mixture of carboxylic acids having from 5 to 9 carbon atoms.

27. The shock absorber of claim 26 further comprising an antioxidant, a corrosion inhibitor, an antiwear additive, a seal conditioner, and combinations thereof.

28. An automotive shock absorber including hydraulic fluid for dampening the movement of associated mechanical members, wherein the improvement comprises hydraulic fluid that is substantially biodegradable, and includes a polyol ester.

29. The shock absorber of claim 28 wherein the polyol component of said polyol ester is a hindered polyol and the carboxylic acid component is a mono-carboxylic acid having from about 5 to 18 carbon atoms.

30. The shock absorber of claim 28 wherein said polyol is trimethylolpropane.

31. The shock absorber of claim 28 wherein said monocarboxylic acid has from about 5 to about 10 carbon atoms.

32. The shock absorber of claim 28 wherein said monocarboxylic acid is branched acid.

33. The shock absorber of claim 32 wherein said branched acid has from about 5 to about 10 carbon atoms.

34. The shock absorber of claim 28 wherein said ester is an ester of trimethylolpropane and a mixture of carboxylic acids having from 5 to 9 carbon atoms.

35. The shock absorber of claim 28 further comprising an antioxidant, a corrosion inhibitor, an antiwear additive, a seal conditioner, and combinations thereof.

36. An automotive shock absorber including hydraulic fluid for dampening the movement of associated mechanical members wherein the improvement comprises hydraulic fluid comprised of an ester of trimethylolpropane and a mixture of carboxylic acids having from 5 to 9 carbon atoms.

37. The shock absorber of claim 36 further comprising an antioxidant, a corrosion inhibitor, an antiwear additive, a seal conditioner, and combinations thereof.
